(19) United States
(12) Patent Application Publication
(10) Pub. No.: US 2010/0273638 A1
(43) Pub. Date: Oct. 28, 2010

(54) SOLID-SOLUTION CARBIDE/CARBONITRIDE POWDER AND METHOD FOR PREPARING THEREOF

(75) Inventor: Shinhoo Kang, Seoul (KR)

Correspondence Address: THE NATH LAW GROUP, 112 South West Street, Alexandria, VA, 22314, US

(73) Assignee: SEOUL NATIONAL UNIVERSITY INDUSTRY FOUNDATION, Seoul (KR)

(21) Appl. No.: 12/745,810

(22) PCT Filed: Dec. 26, 2008
(86) PCT No.: PCT/KR08/07713

§ 371 Date: Jun. 2, 2010

(30) Foreign Application Priority Data
Dec. 26, 2007 (KR) 10-2007-0137578

(51) Int. Cl. C04B 35/56

(52) U.S. Cl. 501/93

(57) ABSTRACT

The present invention relates to a complete solid solution powder used for preparing a cermet composite sintered body, and method for preparing thereof. Particularly, the present invention is directed to a complete solid solution powder which can improve, to a great extent, toughness of a cermet sintered body which is used for high-speed cutting tool materials and die materials in the field of metal working, such as various machine industries and automobile industry, and method for preparing thereof.

### TECHNICAL FIELD

The present invention relates to a complete solid solution powder used for preparing a cermet composite sintered body, and method for preparing thereof. Particularly, the present invention is directed to a complete solid solution powder which can improve, to a great extent, toughness of a cermet sintered body which is used for high-speed cutting tool materials and die materials in the field of metal working, such as various machine industries and automobile industry, and method for preparing thereof.

### BACKGROUND ART

Tungsten carbide (WC)-based hard alloys, various TiC- or Ti(CN)-based cermet alloys, other ceramics or high-speed steels are used for high performance materials for cutting tools or wear-resistant tools which are essentially required in the metal cutting process or metal working process of the machine industries.

Among these, a cermet sintered body is a sintered body of ceramic-metal composite usually containing TiC or Ti(CN) as a hard phase, metals such as Ni, Co and Fe, etc. as a binder phase, as main components, and carbide, nitride or carbonitride of Group IVa, Va and VIa metals in the periodic table such as Ti, Zr, Hf, V, Nb, Ta, Cr, Mo, W, etc.

A cermet sintered body is prepared by mixing TiC or Ti(CN), etc. with a hard ceramic powder such as WC, NbC, TaC, Mo₂C, etc., and a metal powder of Co, Ni, etc. as a binder phase, and then sintering the mixture under vacuum or hydrogen atmosphere.

Among these materials, TiC has very high Vicker's hardness of 3,200 kg/mm², a considerably high melting point of up to 3,150° C. to 3,250° C., and a relatively high oxidation resistance up to 700° C. as well as excellent properties such as wear resistance, corrosion resistance, electromagnetic radiation property, light-collecting property, etc. and, therefore, has been widely used as a substituent for WC—Co alloys which is a high-speed cutting tool material.

However, in the case of preparing a cermet sintered body using TiC as a main component, a binder metal such as Co, Ni, etc. is used as a liquid metal in the sintering process. In this case, since the wetting angle of TiC is larger than that of WC—Co combination, TiC grains grow rapidly, causing the decrease in toughness of the sintered body.

Nevertheless, a TiC—Mo₂C—Ni cermet sintered body was first mass-produced by Ford Motor Company, U.S.A. in 1956. Although this cermet sintered body was not greatly improved in toughness, it had been used as high hardness tool material for precision machining such as semi-finishing and finishing.

In the 1960's and 1970's, many attempts had been made to add various kinds of elements to the TiC—Ni cermet sintered body in order to improve toughness which was the greatest weakness thereof; however, these attempts failed to obtain significant results.

Under these circumstances, Ti(C,N) which is a thermodynamically more stable phase had been formed in the 1970's by the addition of TiN to TiC, resulting in an improvement of toughness to some extent. That is, since Ti(C,N) has a finer microstructure than TiC, toughness of Ti(C,N) could be improved compared to that of TiC, and also chemical stability and mechanical impact resistance of Ti(C,N) could be improved as well.

In addition, technological developments in the addition of WC, Mo₂C, TaC, NbC, etc. to a cermet sintered body in order to enhance the toughness thereof have been in progress such that improved cermet sintered bodies in the forms of Ti(C,N)-M₁C-M₂C— . . . —Ni/Co have been commercialized to date.

When carbides are added in order to enhance toughness of a cermet sintered body, TiC- or Ti(C,N)-based cermet sintered body has generally a microstructure of a core/rim structure in which the hard phase and rim of the core/rim structure is enclosed with a binder phase of Ni, Co, etc.

The core portion of the core/rim structure is TiC or Ti(C,N) portion which is not dissolved in a metal binder (Ni, Co, etc.) which is liquefied during sintering, and has a high hardness.

To the contrary, the rim encapsulating the core is a solid solution (designated as (T₁, M₁, M₂, . . . )(C,N)) between the core component, TiC or Ti(C,N), and the carbide added, and formed around the core, and contributes to the improvement of toughness, rather than hardness, of the cermet sintered body.

As such, the cermet solved, to an extent, the serious drawback, namely, low toughness of the conventional art by enhancing the low toughness (K_{IC}) of a simple cermet system, such as TiC—Ni or Ti(C,N)—Ni, up to 5-7 MPam due to the rim formed during the sintering process.

However, the cermet having the core/rim structure still had a problem that the toughness thereof was much lower than that of the conventional WC—Co cemented carbide and, thus, has not yet substituted completely for the conventional tungsten carbide-cobalt alloys (WC—Co).

As a result, attempts to develop a cermet having improved toughness through the formation of a complete solid solution phase cermet sintered body without having a core/rim structure have been continuously made by manufacturers of tools for metal working, such as Sumitomo, Mitsubishi, etc.

For example, in JP-A Showa 58-213619 (Production of powder of composite carbonitride solid solution; Publication date: Dec. 12, 1983) filed by Nippon Shinkinzoku KK, a solid solution powder was produced by mixing under wet state (a) anatase TiO₂ powder, (b) one or more oxides of, excluding Ti, group IVa (Zr, Hf), group Va (V, Nb, Ta) and group VIa (Cr, Mo, W), and one or more metals thereof, and (c) an amorphous carbon powder for 24 hours at a BPR of 5:1, and then drying the mixture; molding the desired mixture; calcining first the molded mixture under nitrogen atmosphere at 1,200° C. to 1,400° C. for more than 10 min, and then secondly at 1,700° C. to 2,000° C. crushing the calcined molded body to obtain the solid solution powder. According to Examples of the JP-A Showa 58-213619, a carbonitride solid solution powder was produced by mixing TiO₂, C, one or two of Nb₂O₃, ZrO₂, HfO₂, V₂O₅ and Cr₂O₃, and one of W, Mo, Ta. However, according to the JP Showa 58-213619, Ti was excluded, group IVa elements such as Jf, Zr, etc. were not used, and technology that uses a solid solution carbide was not disclosed.

In addition, in JP-A Showa 58-213619 (Manufacture of high strength cermet; Publication date: Dec. 12, 1983) filed by Mitsubishi, it was attempted to form a solid solution by pulverizing and mixing oxides of group IVa, Va and VIa metals at 1,900° C.; however, only a powder which has a core/rim structure and partially contain a solid solution phase was produced after all. The cermet sintered body obtained from such powder has a conventional core/rim structure and showed any particular properties compared with the conventional cermets.

As another prior art which uses metal oxides as starting materials for producing a cermet sintered body, U.S. Pat. No. 5,166,103 discloses a process for production of a cermet sintered body powder by reacting a mixture of WO₃, TiO₂ and C at 1,200° C. to 2,000° C. (preferably, 1,400° C. to 1,450° C.) in an electric vacuum rotary furnace. However, this US patent describes that large amount of W₂C and W was detected since the process of the US patent is a simple physical mixing process and thus phase formation is not complete.

Moreover, U.S. Pat. No. 5,380,688 (Method for making submicrometer carbides, submicrometer solid solution carbides, and the material resulting therefrom; Date of Patent: Jan. 10, 1995) of The Dow Chemical Company discloses that a single carbide such as WC, and a solid solution carbide, with a size of 0.01-1.0 μm, were made by mixing at least one oxide and carbon, and then heating the mixture as rapid as 10²-10⁸° C./sec at 1,550° C. to 1,950° C. (Table 2.).

(W,Ti)C and (W,Mo)C with hcp structure containing small amount of Ti or Mo were produced by the method disclosed in U.S. Pat. No. 5,380,688, of which the oxygen contents were considerably so high as to be 2.7 and 0.36 wt %, respectively, and changed significantly according to Examples (Example 3 and 4 in U.S. Pat. No. 5,380,688). Further, U.S. Pat. No. 5,380,688 relates to (Ti,W)C or (Ti,Mo)C with hcp structure rather than NaCl structure (fcc structure). Even when (Ti,W)C was produced by mixing oxides, the reaction did not proceed completely and, thus, a solid solution and WC (4-25%) which was not solid-solubilized were observed together with W and W₂C even in the range of solid solubility limit of WC, which demonstrates the failure of production of a complete solid solution (Examples 10, 11, 14 and 15 of U.S. Pat. No. 5,380,688). 5-20 wt % of WC and 30-40 wt % of W₂C were observed even in the production of (W,Ta)C and (W,Ti,Ta)C in U.S. Pat. No. 5,380,688 (Examples 10, 11, 14 and 15). U.S. Pat. No. 5,380,688 describes that a solid solution was easily obtained only in the case of (Ti,Ta)C.

Taking Examples 1-15 and results of composite solid solutions (Example 16-37, Table 3) into account, when a solid solution is made from two or more oxides according to the method of U.S. Pat. No. 5,380,688, a mixture of two partial solid solutions, rather than a complete solid solution, is mostly formed and, therefore, a complete solid solution is not formed.

Further, U.S. Pat. No. 5,756,410 (Method for making submicrometer transition metal carbonitrides; Date of Patent: May 26, 1998) of The Dow Chemical Company describes that XRD investigation reveals that all the powders made by the method of this patent consists of a carbonitride solid solution and WC (Examples 1-40 of U.S. Pat. No. 5,756,410).

Furthermore, U.S. Pat. No. 6,007,598 (Metallic-carbide-group VIII metal powder and preparation methods thereof; Date of Patent: Dec. 28, 1999) of OMG Americas, Inc. describes that carbides are prepared by heating rapidly an admixture of starting materials with a heating rate of 10²-10⁸ K/sec and then adjusting a composition of the heated admixture, and heating the adjusted composition at 1,350° C.; however, all the produced powders are simple carbides, WC—Co (Examples 1-3 of U.S. Pat. No. 6,007,598), or composite powders of carbonitrides solid solution (WC—TiC—TaC) and WC—Co (Examples 4-6 of U.S. Pat. No. 6,007,598). The preparation of a complete solid solution powder is not described at all in the specification and Examples of the patent and only a composite powder consisting of a solid solution and other carbides is described.

These prior arts does not describe at all the production of a carbide solid solution powder and a cermet powder which comprises a binder phase, and employ a mixing process where starting materials are mixed in a jar lined with polyurethane at a low speed (for example, 20 rpm) without employing a crushing process.

In addition, cermet sintered body manufacturers such as Treibach, H.C. Starck, etc. produce and sell recently solid solution powders such as (W,Ti)(CN), etc.; however, XRD analyses of such powders and microstructures of sintered bodies of such powders show that such powders have not complete solid solution structures but core/rim microstructures. Consequently, carbonitride solid solution powders with a complete solid solution phase have not been commercialized as yet.

Moreover, Korean Patent No. 10-0528046 and US 2005/0047951 A1 (Publication date: Mar. 3, 2005) which are filed by KOREA INSTITUTE OF SCIENCE AND TECHNOLOGY, disclose a method for fabricating (Ti,TM)C—(Ni, Co) solid solution powder directly from milling the mixture of Ti, transition metal (TM), C, Ni and Co powders, and claim a method for fabricating a sintered body by sintering the (Ti,TM)C—(Ni, Co) solid solution powder. However, since this method uses metal elements as starting materials, cost of production of the solid solution powder of this method is higher compared with that of other method using metal oxides as starting materials. Also, it is difficult to commercialize this method since mass production according to this method is impossible. The above-mentioned is described in detail in “Mechanochemical synthesis of nanocomposite powder for ultra-fine (Ti,Mo)C—Ni cermet without core-rim structure”, Int. J. Ref. Met. Hard Met., 22(4-5), 2004, pp 193-196.

Besides these conventional techniques, there are many patents, such as U.S. Pat. No. 5,166,103, U.S. Pat. No. 6,793,875, etc., and papers on the production of carbides by methods similar to these conventional techniques. However, those are related to the production of carbide mixed powders, not complete solid solution powders.

General information on the production of a solid solution powder is described in Korean Patent No. 10-0626224 (solid solution powder, method to prepare the same, powder for cermet including said solid solution powder, method to prepare the same and cermet using said powder for cermet) of the present inventor, which describes a method for preparing carbide or carbonitride by mixing a said solid solution with oxides of corresponding metal elements (when nanometer-sized metal oxides are used), or mixing and crushing a said solid solution with oxides of corresponding metal elements, and then reducing, carburizing and nitriding the mixture.

A sintered cermet made from the powders prepared by this method has a toughness of 9-12 MPam¹¹² which matches toughness of tungsten carbide-cobalt alloy and, therefore, it has a market potential for a novel carbide cermet.

However, when metal oxides are used as starting materials, residual oxygen content of the solid solution produced is 0.4-1.5 wt % which is higher than <1.0 wt %, general standard value of oxygen content for commercial carbides (or carbonitrides). Also, since it is not easy to control residual oxygen content, pores are frequently formed within the microstructure of the sintered body produced by using such solid solution powder.

These problems are well demonstrated in Table 1 (oxygen content of 1.1-1.14 wt %), FIGS. 3 and 5 of Sangho PARK and Shinhoo KANG, “Toughened ultra-fine (Ti,W)(CN)Ni cermets”, Scripta Materialia, Volume 52, Issue 2, 129-133 (2005).

These problems of the conventional techniques relating to this technique is also described in another paper of the present inventor, “Synthesis of (Ti,M1,M2)(CN)—Ni nanocrystalline powders, S. Park, Y. J. Kang, H. J. Kwon and S. Kang, International Journal of Refractory Metals & Hard Materials, 24, 115121 (2006), and “Sintered (Ti,W)C carbides”, J. Jung and S. Kang, Scripta Materialia, 56, 561-564 (2007).

Consequently, since, according to a method for producing a solid solution powder by using metal oxides as a starting material by the conventional technique, size of powder crystallites obtained thereby is small, process temperature is low, and manufacturing process is simple, the method has a considerable market potential and competitive power for tungsten carbide cobalt-alloy. However, it is difficult to obtain a sintered body with microstructure without pore. Up to now, a technology that can control the amount of oxygen and carbon contained in a solid solution powder in order to optimize the production of a commercially available sintered body, i.e., a cermet for cutting tools, has not been developed.

### DISCLOSURE

### Technical Problem

The present invention is to provide a novel method for preparing a solid solution powder for a cermet sintered body, which makes it possible to manufacture a high performance cutting tool. In particular, the object of the present invention is to solve the above-mentioned problems of the prior art and to provide a novel method for controlling an oxygen and carbon content of the powder for a cermet sintered body.

In order to solve a problem that the conventional TiC- and Ti(CN)-based cermet have low toughness in spite of their high hardness, the present invention is to provide a novel method for minimizing an amount of oxygen residing within the powder for a cermet sintered body by making it easier a procedure of removing oxygen from metal oxide through reduction, when producing a complete solid solution powder without a core/rim structure by using metal oxide as a starting material.

Since residual oxygen content of the powder for a cermet sintered body, prepared by the method of the present invention, is small, possibility of the formation of pores during sintering the powder for a cermet sintered body can be minimized, thereby substantially improving toughness of the powder for a cermet sintered body to a great extent as well as general mechanical properties thereof. In addition, when a cermet sintered body is prepared by using the carbonitride solid solution powder of the present invention, an amount of tungsten being used decreases and, therefore, cost of raw materials can be curtailed and manufacturing process can be considerably simplified.

### Technical Solution

The primary object of the present invention can be achieved by providing a complete solid solution powder of carbide or carbonitride of at least two metals, including Ti, selected from the group consisting of Ti, Zr, Hf, V, Nb, Ta, Cr, Mo and W, wherein starting materials for the preparation of the complete solid solution powder comprise the at least two metals, an oxide thereof and a carbon powder.

Another object of the present invention can be achieved by providing a sintered body of a complete solid solution powder of carbide or carbonitride of at least two metals, including Ti, selected from the group consisting of Ti, Zr, Hf, V, Nb, Ta, Cr, Mo and W, wherein starting materials for the preparation of the complete solid solution powder comprise the at least two metals, an oxide thereof and a carbon powder.

Yet another object of the present invention can be achieved by providing a compacting of carbide or carbonitride of at least two metals, including Ti, selected from the group consisting of Ti, Zr, Hf, V, Nb, Ta, Cr, Mo and W, wherein starting materials for the preparation of the powder are a complete solid solution powder comprising the at least two metals, oxides of the at least two metals, and carbon powder; and an aggregate comprising at least one metal selected from the group consisting of nickel, iron and cobalt.

Still another object of the present invention can be achieved by providing a cermet prepared by sintering a cermet powder of carbide or carbonitride of at least two metals, including Ti, selected from the group consisting of Ti, Zr, Hf, V, Nb, Ta, Cr, Mo and W, wherein starting materials for the preparation of the powder are a complete solid solution powder comprising the at least two metals, oxides of the at least two metals, and carbon powder; and an aggregate comprising at least one metal selected from the group consisting of nickel, iron and cobalt.

Further another object of the present invention can be achieved by providing a method for preparing a complete solid solution powder, comprising: i) step 1 of mixing, or mixing and grinding at least two metals, including Ti, selected from the group consisting of Ti, Zr, Hf, V, Nb, Ta, Cr, Mo and W, oxides of the at least two metals, and carbon powder; and ii) step 2 of reducing and carburizing, or reducing, carburizing and nitriding the mixed, or mixed and ground powder.

At the step 2 of the method of the present invention, when producing a complete solid solution carbide, the powder is preferably reduced and carburized at 1,100° C. to 1,400° C. for less than 3 hours under vacuum or hydrogen atmosphere, and when producing a complete solid solution carbonitride, the powder is preferably reduced, carburized and nitrided at 1,100° C. to 1,400° C. for less than 3 hours under nitrogen atmosphere.

Furthermore, another object of the present invention can be achieved by providing a method for preparing a sintered body, comprising: i) step 1 of mixing, or mixing and grinding at least two metals, including Ti, selected from the group consisting of Ti, Zr, Hf, V, Nb, Ta, Cr, Mo and W, oxides of the at least two metals, and carbon powder; ii) step 2 of reducing and carburizing, or reducing, carburizing and nitriding the mixed, or mixed and ground powder; and iii) step 3 of compacting and sintering the complete solid solution powder obtained at the step 2.

At the step 2 of the method for preparing a sintered body of the present invention, when producing a complete solid solution carbide, the powder is preferably reduced and carburized at 1,100° C. to 1,400° C. for less than 3 hours under vacuum or hydrogen atmosphere, and when producing a complete solid solution carbonitride, the powder is reduced, carburized and nitrided at 1,100° C. to 1,400° C. for less than 3 hours under nitrogen atmosphere.

At the step 3 of the method for preparing a sintered body of the present invention, the complete solid solution powder is preferably sintered at 1,250° C. to 1,600° C. for 0.1 to 3 hours under vacuum or nitrogen atmosphere.

Moreover, another object of the present invention can be achieved by providing a method for preparing a cermet powder, comprising: i) step 1-2 of mixing, or mixing and grinding at least one oxide selected from the group consisting of nickel, cobalt and iron, at least two metals, including Ti, selected from the group consisting of Ti, Zr, Hf, V, Nb, Ta, Cr, Mo and W, oxides of the at least two metals, and carbon powder; and ii) step 2-2 of reducing and carburizing, or reducing, carburizing and nitriding said mixed, or mixed and ground powder.

At the step 2-2 of the method for preparing the cermet powder of the present invention, when producing a complete solid solution carbide, the powder is preferably reduced and carburized at 1,100° C. to 1,400° C. for less than 3 hours under vacuum or hydrogen atmosphere, and when producing a complete solid solution carbonitride, the powder is reduced, carburized and nitrided at 1,100° C. to 1,400° C. for less than 3 hours under nitrogen atmosphere.

Still, another object of the present invention can be achieved by providing a method for preparing a cermet, comprising: i) step 1-2 of mixing, or mixing and grinding an oxide of at least one selected from the group consisting of nickel, cobalt and iron, at least two metals, including Ti, selected from the group consisting of Ti, Zr, Hf, V, Nb, Ta, Cr, Mo and W, oxides of the at least two metals, and carbon powder; ii) step 2-2 of reducing and carburizing, or reducing, carburizing and nitriding the mixed, or mixed and ground powder; and iii) step 2-3 of compacting and sintering the cermet powder obtained at the step 2-2.

At the step 2-2 of the method for preparing a cermet of the present invention, when producing a complete solid solution carbide, the powder is preferably reduced and carburized at 1,100° C. to 1,400° C. for less than 3 hours under vacuum or hydrogen atmosphere, and when producing a complete solid solution carbonitride, the powder is reduced, carburized and nitrided at 1,100° C. to 1,400° C. for less than 3 hours under nitrogen atmosphere.

At the step 2-3 of the method for preparing a cermet of the present invention, the complete solid solution powder is preferably sintered at 1,250° C. to 1,600° C. for 0.1 to 3 hours under vacuum or nitrogen atmosphere.

Still, another object of the present invention can be achieved by providing a method for preparing a cermet powder, comprising: i) mixing, or mixing and grinding at least two metals, including Ti, selected from the group consisting of Ti, Zr, Hf, V, Nb, Ta, Cr, Mo and W, oxides of the at least two metals, and carbon powder; ii) reducing and carburizing, or reducing, carburizing and nitriding the mixed, or mixed and ground powder to prepare a complete solid solution powder; and iii) adding at least one metal selected from the group consisting of nickel, cobalt and iron to the complete solid solution powder.

At the step ii) of the method for preparing the cermet powder of the present invention, when producing a complete solid solution carbide, the powder is preferably reduced and carburized at 1,100° C. to 1,400° C. for less than 3 hours under vacuum or hydrogen atmosphere, and when producing a complete solid solution carbonitride, the powder is reduced, carburized and nitrided at 1,100° C. to 1,400° C. for less than 3 hours under nitrogen atmosphere.

The complete solid solution powder for a cermet sintered body, the cermet powder comprising the complete solid solution powder, and the cermet sintered body prepared by using the cermet powder, according to the present invention, contain a complete solid solution, and volume fraction of the solid solution phase remarkably increases (>70%), in comparison with the total volume of the alloy. Therefore, toughness of the cermet sintered body provided by the present invention greatly increases.

In addition, according to the method for preparing a solid solution powder and a method for preparing the cermet powder of the present invention, a powder with a uniform microstructure with only a complete solid solution phase, rather than a core/rim structure of the sintered body of the conventional powder for a cermet sintered body, can be prepared through mixing, or mixing and grinding at least two metals, including Ti, selected from the group consisting of Ti, Zr, Hf, V, Nb, Ta, Cr, Mo and W, oxides of the at least two metals, and carbon powder, and then reducing and carburizing, or reducing, carburizing and nitriding the mixed, or mixed and ground powder. Also, a cermet sintered body can be provided by directly sintering the complete solid solution powder of the present invention, without additional mixing step.

A powder with a uniform microstructure with only a complete solid solution phase, rather than a core/rim structure of the sintered body of the conventional powder for a cermet sintered body, can be prepared through mixing, or mixing and grinding at least two metals, including Ti, selected from the group consisting of Ti, Zr, Hf, V, Nb, Ta, Cr, Mo and W, oxides of the at least two metals, and carbon powder, and then reducing and carburizing, or reducing, carburizing and nitriding the mixed, or mixed and ground powder, and a cermet sintered body is prepared by mixing such solid solution powder with a nickel, iron or cobalt powder and then sintering the mixture.

Moreover, according to the method for preparing a complete solid solution powder of the present invention, especially when forming a carbonitride, the amounts of oxygen, carbon and nitrogen are suitably controlled through reducing and carburizing the mixed, or mixed and ground powder and then nitriding the reduced and carburized powder at temperature of 1,100° C. to 1,700° C., so as to have the technical effect of preventing the cermet sintered body from pores and improving other mechanical properties thereof.

According to the present invention, a carbide or carbonitride solid solution powder with a complete solid solution phase is prepared through the steps of mixing at least two metals, including Ti, selected from the group consisting of Ti, Zr, Hf, V, Nb, Ta, Cr, Mo and W, oxides of the at least two metals, and carbon powder, and, if necessary, grinding the mixture by high energy ball milling, and then reducing, carburizing and/or nitriding the mixture.

That is, according to the present invention, at least two metals, including Ti, selected from the group consisting of Ti, Zr, Hf, V, Nb, Ta, Cr, Mo and W, oxides of the at least two metals, for example, Ti, W, Mo, Ta, Nb, TiO₂, WO₃, MoO, TaO, NbO, etc., and carbon powder are mixed, or mixed and ground (step 1) in order to prepare a TiC-based solid solution powder.

In addition, according to the present invention, for example, at least one selected from the group consisting of nickel, cobalt and iron, or oxide thereof; at least one metal selected from the group IVa, Va and VIa metals, and oxide of the at least one metal, such as Ti, W, Mo, Ta, Nb, TiO₂, WO₃, MoO, TaO, NbO, etc.; and carbon powder are mixed, or mixed and ground (step 1-2) in order to prepare a powder for a cermet sintered body.

In the step 1-2, the mixture ratio between at least two metals, including Ti, selected from the group consisting of Ti, Zr, Hf, V, Nb, Ta, Cr, Mo and W can be selected based on the desired composition of the solid solution. Additionally, a high energy ball mill, such as an attrition mill, a planetary mill, etc., may be used in the grinding process.

The solid solution powder with a complete solid solution phase can be easily provided by the present invention through such ball milling procedure.

TiC-based solid solution powder with a complete solid solution phase can be prepared by reducing and carburizing the mixed and/or ground powder, for example under vacuum or hydrogen atmosphere (step 2). The oxygen content of the thus prepared carbide powder plays a very important role in the next sintering procedure. Since increase of the oxygen content generally tends to form pores, it is necessary to control properly or minimize the oxygen content.

Therefore, the mixed and/or ground powder is reduced and carburized under vacuum or hydrogen atmosphere at 1,100° C. to 1,400° C. for not exceeding 3 hours, depending on degree of grinding. As a result, the reduced and carburized powder has a similar oxygen content to a cermet powder which is commercially available at present, and thus helps to enhance physical properties of the cermet sintered body.

In order to prepare Ti(CN)-based solid solution powder, nitrogen is injected into a vacuum furnace during heating the mixed and/or ground powder (step 1, step 1-2) under vacuum, and then the reduction, carburization and nitriding of the mixed and/or ground powder simultaneously take place at 1,100° C. to 1,400° C. for not exceeding 3 hours. Then, Ti(CN)-based solid solution powder with a complete solid solution phase is provided (step 2, step 2-2).

The oxygen content of the thus prepared carbonitride powder is also very important. Since increase of the oxygen content generally tends to form pores, it is necessary to minimize the oxygen content and control properly the carbon and nitrogen content.

Consequently, the mixed and/or ground powder is reduced, carburized and nitrided under vacuum, or hydrogen and nitrogen atmosphere at 1,100° C. to 1,400° C. for not exceeding 3 hours, depending on degree of grinding. The residual oxygen content of the solid solution powder for a cermet sintered body prepared by the method of the present invention is much less than that of a solid solution powder according to the conventional art.

The nitrogen content of the complete solid solution of the present invention may be controllable based on a process temperature, a partial pressure of nitrogen during powder synthesis and an amount of carbon added to the powder. Especially, carbon/nitrogen (molar ratio) is preferably 3/7, 5/5, or 7/3 for a stable composition.

In order to prepare a cermet powder by using the solid solution powder of the present invention, a binder metal such as nickel, cobalt, iron or nickel/cobalt, etc. is mixed, or mixed and ground (step 1-2).

The cermet powder is provided by reducing and carburizing under vacuum or hydrogen atmosphere, or reducing, carburizing and nitriding the mixed and/or ground powder under vacuum or hydrogen and nitrogen atmosphere at 1,100° C. to 1,400° C. for not exceeding 3 hours, depending on the degree of grinding.

TiC- or Ti(CN)-based cermet sintered body with complete solid solution phase is prepared by sintering the cermet powder of the present invention under vacuum at an ordinary sintering temperature for an ordinary sintering time.

As described above, a complete solid solution powder having desired compositions of (Ti,M1,M2, . . . )C and (Ti,M1,M2, . . . )(C,N) which have not a core/rim structure, a cermet powder comprising the complete solid solution powder, and a cermet sintered body prepared from the cermet powder can be produced according to the present invention.

The sizes of the powders may be controlled by regulating the grinding conditions such as time, rate, temperature, etc., and synthesis conditions such as time, temperature, etc. Nanometer-sized, submicrometer-sized (more than 100 nm, less than 1 μm) and micrometer-sized complete solid solution powders and cermet powders can be prepared according to the method of the present invention.

Fabricating facilities and processes for the conventional cermet powder with the size of more than submicrometer had already been commercialized. Since the complete solid solution of the present invention not having a core/rim structure can be prepared in the fabricating facilities for the conventional cermet powder, the methods of the present invention are easily applicable to the existing facilities and also economical.

### DESCRIPTION OF DRAWINGS

FIG. 1 illustrates graphs of X-ray diffraction (XRD) phase analysis results of the powders prepared by mixing and grinding the mixtures of Ti, TiO₂, WO₃ and C in which the ratio of TiO₂:Ti are (a) 0:1, (b) 1:1, (c) 2:1 and (d) 1:0, respectively, according to Example 1 of the present invention.

FIG. 2 illustrates graphs of X-ray diffraction (XRD) phase analysis results of the (Ti_{0.7}W_{0.3})C solid solution powders produced by reducing and carburizing the powders prepared by mixing and grinding the mixtures of Ti, TiO₂, WO₃ and C, in which the ratio of TiO₂:Ti are (a) 0:1, (b) 1:1, (c) 2:1 and (d) 1:0, respectively, according to Example 1 of the present invention.

FIG. 3 illustrates shows field emission scanning electron microscopy (FESEM) images of the microstructures of the (Ti_{0.7}W_{0.3})C-20 wt % Ni cermet sintered bodies produced by reducing and carburizing the powders prepared by mixing and grinding the mixtures of Ti, TiO₂, WO₃ and C, in which the ratio of TiO₂:Ti are (a) 0:1, (b) 2:1, (c) 4:1 and (d) 1:0, respectively, according to Example 4 of the present invention.

FIG. 4 illustrates graphs of XRD phase analysis of the (Ti_{0.7}W_{0.3})C solid solution powders produced by reducing and carburizing, through heat-treating at 1,250° C. for 2 hours, the powders prepared by mixing and grinding the mixtures of Ti, TiO₂, WO₃ and C, in which the ratio of TiO₂:Ti are (a) 0:1, (b) 1:1, (c) 2:1 and (d) 1:0, respectively, according to Example 2 of the present invention.

FIG. 5 illustrates the XRD results of the milled powders and the reduced and carburized powders, depending on the conditions of adding NiO. FIG. 5(a) illustrates the XRD results of the planetary-milled powder of Ti+WO₃+C, which shows that TiC phase was mainly formed. FIG. 5(b) illustrates the XRD results of the mixture prepared by mixing the powder of FIG. 5(a), and NiO and C in the planetary mill, in which NiO and C peaks are definitely shown. FIG. 5(c) illustrates the XRD results of the powders prepared by reducing and carburizing the powders of FIG. 5(b) at 1,250° C. for 2 hours, in which only TiC solid solution and Ni are observed. FIG. 5(d) illustrates the XRD results of the powders to which NiO was added during planetary milling, which shows that NiO is observed to be to some extent milled, compared with FIG. 5(b). FIG. 5(e) illustrates the XRD results of the powders prepared by reducing and carburizing the powders of FIG. 5(d), which shows the same result as FIG. 5(c).

FIG. 6 illustrates the XRD results of the powders prepared by reducing and carburizing the powders of FIG. 5(b) at 1,150° C., 1,200° C. and 1,250° C. for 2 hours. As can be seen in FIG. 6, powders and sintered bodies having only solid solution phase and Ni phase were obtained at such low temperatures as 1,150° C. and 1,200° C.

FIG. 7 shows field emission scanning electron microscopic (FESEM) images of the microstructures of the (Ti_{0.7}W_{0.3})C-20 wt % Ni cermet sintered bodies produced by reducing and carburizing the powders prepared by mixing and grinding the mixtures of Ti, TiO₂, WO₃ and C, in which the ratio of TiO₂:Ti are (a) 0:1, (b) 2:1, (c) 4:1 and (d) 1:0, respectively, according to Example 4 of the present invention.

FIG. 8 illustrates the XRD results of the powders prepared by reducing and carbonitriding the milled powders. It is observed that solid solution carbonitrides were formed in all compositions of (a) (Ti_{0.7}W_{0.3})(CN), (b) (Ti_{0.88}W_{0.12})(CN) and (c) (Ti_{0.93}W_{0.07})(CN).

FIG. 9 illustrates the FESEM images of the microstructures of the sintered bodies of the (Ti₁₋ₓWₓ)(CN)-20 wt % Ni (x=0.07, 0.12, 0.30) cermet powders which were produced by reducing and carburizing the powders prepared by mixing the starting materials so as to be the TiO₂:Ti ratio of 4:1 and grinding thereof, according to Example 6 of the present invention.

FIG. 10 illustrates the FESEM images of the sintered body which was prepared by sintering the (Ti_{0.93}W_{0.07})C-20 wt % Ni cermet powders at 1,510° C. for 1 hour under nitrogen atmosphere (at about 100 torr).

FIG. 11 illustrates the FESEM image of the surface of the sintered body which was prepared by sintering the (Ti_{0.84}W_{0.16})C-20 wt % Ni cermet powders at 1,510° C. for 1 hour under nitrogen atmosphere (at about 100 torr).

FIG. 12 the FESEM image of the surface of the TiN coating layer coated by PVD after sintering the (Ti,W)C—Ni cermet powders (containing 15 wt % of WC) at 1,510° C. for 1 hour.

FIG. 13 illustrates the SEM and TEM images of the (Ti_{0.8}W_{0.2})C powders prepared by the one embodiment of the present invention.

FIG. 14 illustrates the photographs of the microstructures of the samples of (1) the (Ti_{0.8}W_{0.2})C sintered body fabricated at 1,120° C., (2) the (Ti_{0.7}W_{0.3})C sintered body fabricated at 1,120° C., (3) the (Ti_{0.6}W_{0.4})C sintered body fabricated at 1,200° C. and (4) the (Ti_{0.5}W_{0.5})C sintered body fabricated at 1,200° C., respectively.

FIG. 15 illustrates the sectional images of the samples of FIG. 14.

### BEST MODE

Hereinafter, the present invention will be described in greater detail with reference to the following examples. The examples are given only for illustration of the present invention and not to be limiting the present invention. The following examples are intended to complete the disclosure of the present invention and to easily embody the present invention by those skilled in the art. Furthermore, it can be understood by those skilled in the art that the following examples may be variously modified within the accompanying claims.

### Example 1

In order to produce a complete solid solution with the composition of (Ti_{0.7}W_{0.3})C, Ti metal, anatase TiO₂, WO₃ and carbon powder were prepared. Four mixtures in which the mixture ratios of TiO₂ and Ti were 1:0, 1:1, 2:1 and 0:1, respectively, were prepared, and WO₃ and carbon powder were mixed therewith. The thus prepared four mixtures were ground in a planetary mill, using WC—Co balls, at 250 rpm and with BPR (ball-to-powder ratio) of 40:1, in a dry state for 20 hours, and then were reduced and carburized by heat-treatment at 1,250° C. for 2 hours under vacuum.

Considering that most reduction procedures proceed with the emission of CO gases, the amount of carbon being added was determined based on the calculation that 3 moles carbon per 1 mole TiO₂ is required when TiO₂ is used to produce carbide, and 1 mole carbon per 1 mole Ti is required when Ti is used to produce carbide. Consequently, the amount of carbon was controlled depending on the compositions of raw materials so that residual carbons may not remain. The weights of raw materials used to prepare the target composition of (Ti_{0.7}W_{0.3})C are listed in Table 1.

TABLE 1

| | | | | | carbon | |
|---|---|---|---|---|---|---|
| TiO₂:Ti | | | | | content | oxygen |
| weight | raw materials (g/batch) | | | | in carbide | content in |
| ratio | TiO₂ | Ti | WO₃ | C | (%) | carbide (%) |
| (a) 0:1 | 0 | 8.7893 | 18.2286 | 5.9821 | 11.35 | 0.453 |
| (b) 1:1 | 4.9199 | 4.9199 | 16.3235 | 6.8367 | 10.93 | 0.391 |
| (c) 2:1 | 6.8321 | 3.4160 | 15.5830 | 7.1688 | 10.68 | 0.295 |
| (d) 1:0 | 11.1756 | 0 | 13.9011 | 7.9233 | 10.57 | 0.386 |

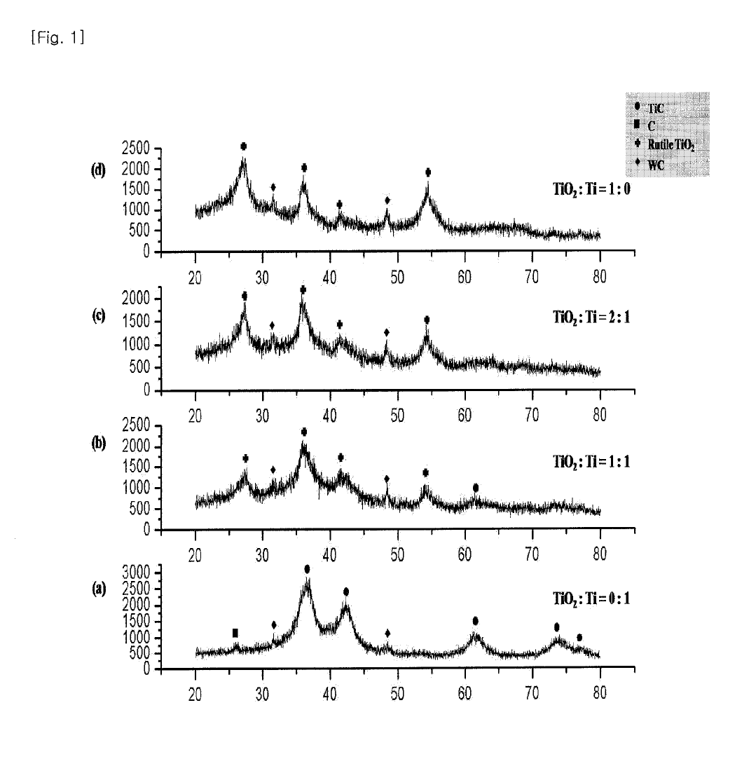

FIG. 1 illustrates graphs of X-ray diffraction (XRD) phase analysis of the powders prepared by mixing and grinding the mixtures of Ti, anatase TiO₂, WO₃ and C in which the ratio of TiO₂:Ti are (a) 0:1, (b) 1:1, (c) 2:1 and (d) 1:0, respectively, according to Example 1 of the present invention.

FIG. 1(a) shows that nanocrystallites or amorphous substance comprising TiC (2θ=near 37°, 62°) after grinding the mixture of T₁, WO₃ and C. When TiO₂ was not used and only Ti was used (TiO₂:Ti=0:1), most phases appeared near TiC peaks, and WC which was incorporated, due to wear, from WC—Co milling balls was also observed.

Fig. (b), (c) and (d) show that TiC formation decreased and newly formed rutile TiO₂ (2θ=near 36°, 42°) increased, with increasing anatase TiO₂, a starting material. According to these results, when Ti metal is present in the oxide powder prepared by mixing and grinding anatase TiO₂, etc., it is assumed that Ti metal was converted to oxycarbide such as Ti(C,O) which is easily reduced by grinding.

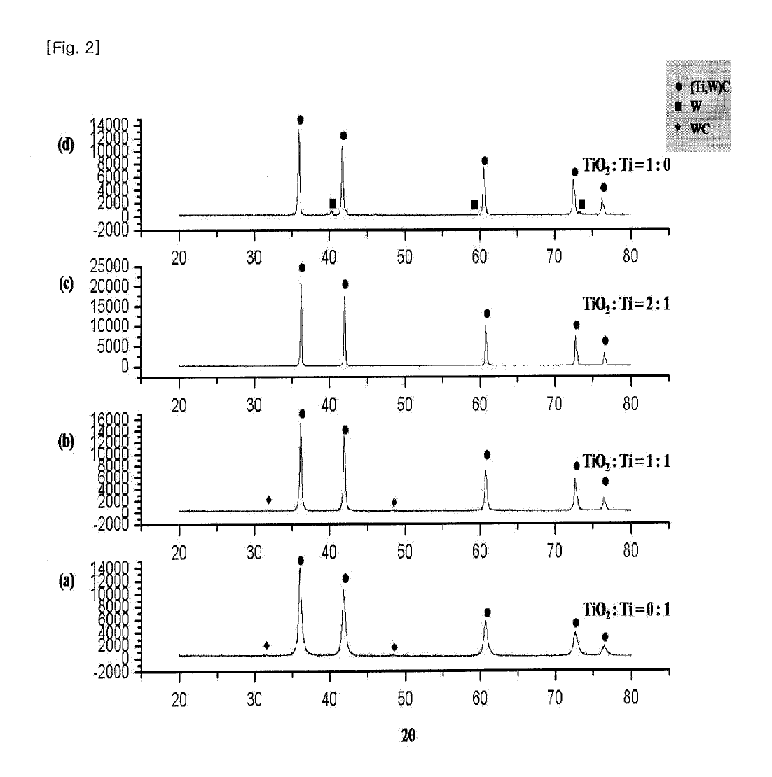

FIG. 2 illustrates the XRD results of the powders reduced and carburized in a graphite vacuum furnace at 1,250° C. for 2 hours. All powders which were heat-treated at 1,250° C. for 2 hours, were changed to (Ti,W)C phases. When TiO₂:Ti=0:1, there was any other phase except (Ti_{0.7},W_{0.3})C and WC which was incorporated as an impurity during grinding. When TiO₂:Ti=1:0, W was observed. These results were because W was not carburized due to insufficient amount of carbon or W which was not solid solubilized into the solid solution was present. These results were also noticeable with the increase of TiO₂, and are construed as carbon deficiency became larger proportional to the increase of TiO₂.

Therefore, it was interpreted that residual carbon is required during carburizing process when only TiO₂ is used. In addition, agglomeration took place when the powder contained large amount of TiO₂, which seemed to be due to the presence of metal such as W. The XRD results showed that, as the amount of Ti increased, the full width half maximum (FWHM) of the (Ti,W)C peaks increased and the sizes of the powders decreased. This was due to the synthesis of TiC during milling.

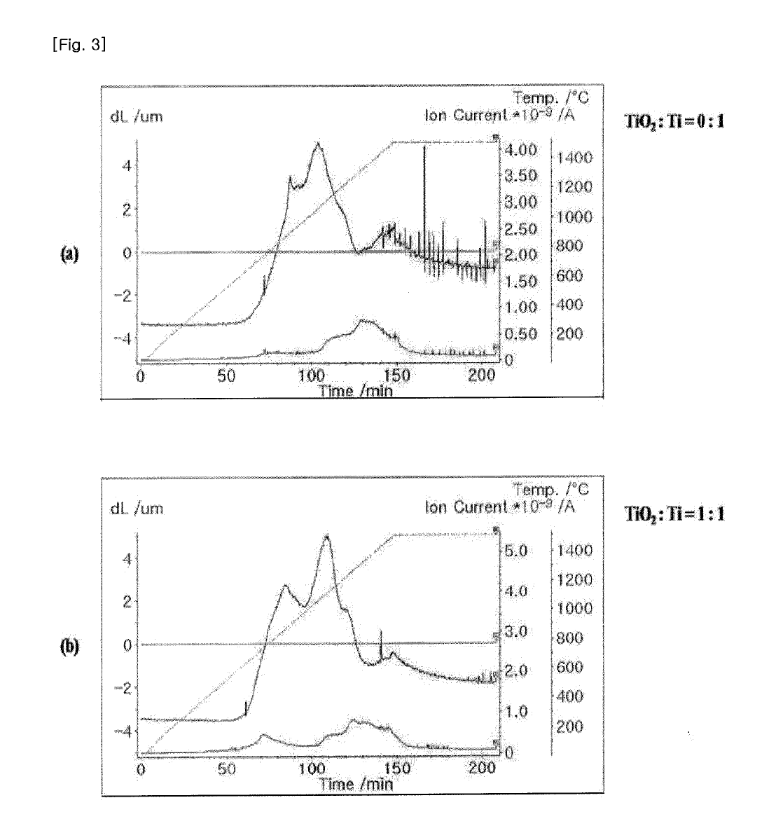

FIG. 3 shows the mass spectrometric results of the powders which measured the amounts of CO and CO₂ gases produced during heating the powders from ambient temperature to 1,500° C. at a rate of 10° C./min. The mass spectrometric results of the milled powders in which initial ratios of TiO₂ and Ti were 0:1 and 1:1, showed that most CO gases had been emitted below 1,300° C. but CO gases had been emitted at around 1,500° C. The CO gases emitted decreased as the ratio of Ti decreased. The amount of CO₂ gases indicated in the lower part was negligible.

Table 1 shows the carbon and oxygen contents of the powders obtained from the four compositions and processes of Example 1. Residual oxygen contents were very low (<0.5 wt %) in all the cases. When only Ti was used, stoichiometric carbon content was measured, and when TiO₂ was used together with Ti, overall carbon content decreased.

It can be understood from Example 1 that a complete solid solution such as (Ti_{0.7}W_{0.3})_{C} can be obtained in all the cases of (a)-(d) by reduction and carburization at 1,250° C. for 2 hours, and also that crystallite sizes of the solid solution powders decrease as the amount of Ti added increases. Moreover, it was shown that overall reduction process proceeded easily when Ti was used together with TiO₂.

### Example 2

In order to produce a complete solid solution with the composition of (Ti_{0.7}W_{0.3})C, Ti metal, anatase TiO₂, WO₃ and carbon powder were prepared. Four mixtures in which the mixture ratios of TiO₂ and Ti were 1:0, 1:1, 2:1 and 0:1, respectively, were prepared, and WO₃ and carbon powder were mixed therewith. The thus prepared four mixtures were ground in a planetary mill, using WC—Co balls, at 250 rpm and with BPR (ball-to-powder ratio) of 30:1, in a dry state for 20 hours, and then were reduced and carburized by heat-treatment at 1,250° C. for 2 hours under vacuum.

Considering that most reduction procedures proceed with the emission of CO gases, the amount of carbon being added was determined based on the calculation that 3 moles carbon per 1 mole TiO₂ is required when TiO₂ is used to produce carbide, and 1 mole carbon per 1 mole Ti is required when Ti is used to produce carbide.

Residual carbon was added in order to solve the problem that the amount of carbon became deficient during milling process when the powders were contaminated by WC and the amount of TiO₂ added was large. The amount of the residual carbon was as much as the stoichiometrically deficient amount of carbon, based on the carbon content in Table 1. The weights of raw materials used are listed in Table 2.

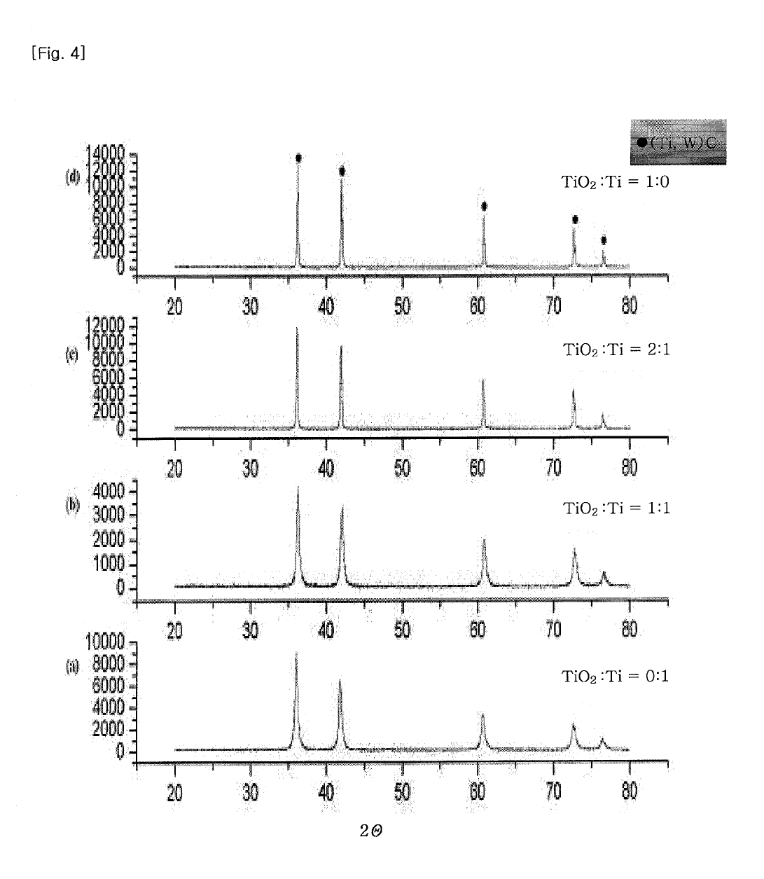

FIG. 4 illustrates graphs of XRD phase analysis of the (Ti_{0.7}W_{0.3})C solid solution powders produced by reducing and carburizing, through heat-treating at 1,250° C. for 2 hours, the powders prepared by mixing and grinding the mixtures of Ti, TiO₂, WO₃ and C, in which the ratio of TiO₂:Ti are (a) 0:1, (b) 1:1, (c) 2:1 and (d) 1:0, respectively, according to Example 2 of the present invention. All the powders used in this Example formed (Ti,W)C solid solutions, and crystallite sizes thereof were as small as 30 nm to 40 nm (measured according to Scherer's method) as Ti added increased. In contrast to the powders milled with BPR of 40:1 (Example 1), it can be understood that, when BPR was 30:1, WC was not incorporated into the four powders due to abrasion and thus powders with only pure (Ti,W)C solid solution were produced.

TABLE 2

| | | | | | carbon | |
|---|---|---|---|---|---|---|
| TiO₂:Ti | | | | | content | oxygen |
| weight | raw materials (g/batch) | | | | in carbide | content in |
| ratio | TiO₂ | Ti | WO₃ | C | (%) | carbide (%) |
| (a) 0:1 | 0 | 8.7893 | 18.2286 | 6.2487 | 11.68 | 0.286 |
| (b) 1:1 | 4.9199 | 4.9199 | 16.3235 | 7.0754 | 11.33 | 0.306 |
| (c) 2:1 | 6.8321 | 3.4160 | 15.5830 | 7.3968 | 11.26 | 0.0914 |
| (d) 1:0 | 11.1756 | 0 | 13.9011 | 8.1266 | 11.85 | 0.148 |

Table 2 shows the residual carbon and oxygen contents of the powders obtained from the starting material compositions and processes of Example 2. Stoichiometric carbon content of (Ti_{0.7}W_{0.3})C is 11.93%, and thus carbon content was very deficient when residual carbon was not added. When residual carbon was added, carbon content was detected as much as about 11.93% and all the powders of Example 2 had low oxygen contents of below 0.4%, compared with those of Example 1 in which residual carbon was not added.

It can be known from Example 2 that (Ti,W)C solid solution can be easily prepared even when BPR is as low as 30:1, that WC contamination from WC—Co balls can be removed, and that degree of carburization of carbides can be controlled by adjusting the amount of carbon added.

### Example 3

The cermet powders were synthesized by mixing and grinding the mixture of Ti, WO₃ and NiO followed by reduction and carburization thereof. In order to prepare (Ti_{0.7}W_{0.3})C-20 wt % Ni cermet powders with (Ti_{0.7}W_{0.3})C complete solid solution were synthesized by reducing and carburizing two types of powders which were prepared, respectively, by (1) grinding the mixture of Ti, WO₃ and carbon in a planetary mill at 250 rpm for 20 hours in a dry state followed by further mixing NiO by horizontal ball milling for 24 hours, and (2) grinding the mixture of Ti, WO₃, carbon and NiO in a planetary mill at 250 rpm for 20 hours in a dry state. The reduction and carburization process was carried out by using a graphite vacuum furnace at 1,150° C., 1,200° C. and 1,250° C. for 2 hours.

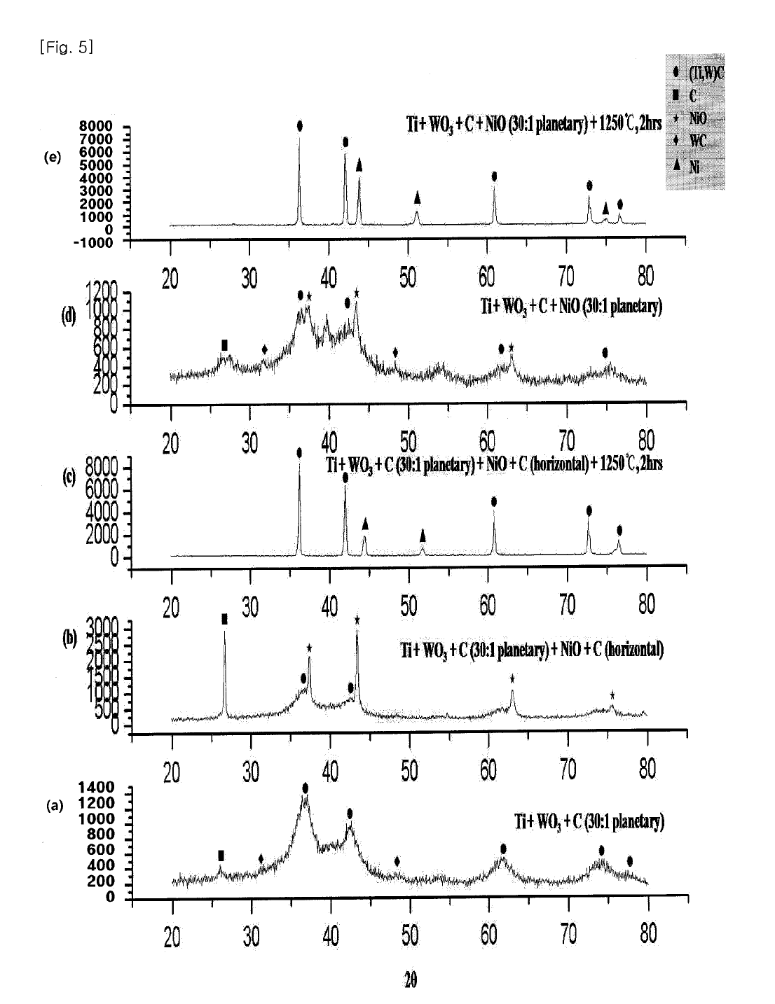

FIG. 5 illustrates the XRD results of the milled powders and the reduced and carburized powders, depending on the conditions of adding NiO. FIG. 5(a) illustrates the XRD results of the planetary-milled powder of Ti+WO₃+C, which shows that TiC phase was mainly formed. FIG. 5(b) illustrates the XRD results of the mixture prepared by mixing the powder of FIG. 5(a), and NiO and C in the planetary mill, in which NiO and C peaks are definitely shown.

FIG. 5(c) illustrates the XRD results of the powders prepared by reducing and carburizing the powders of FIG. 5(b) at 1,250° C. for 2 hours, in which only TiC solid solution and Ni are observed.

FIG. 5(d) illustrates the XRD results of the powders to which NiO was added during planetary milling, which shows that NiO is observed to be to some extent milled, compared with FIG. 5(b). FIG. 5(e) illustrates the XRD results of the powders prepared by reducing and carburizing the powders of FIG. 5(d), which shows the same result as FIG. 5(c).

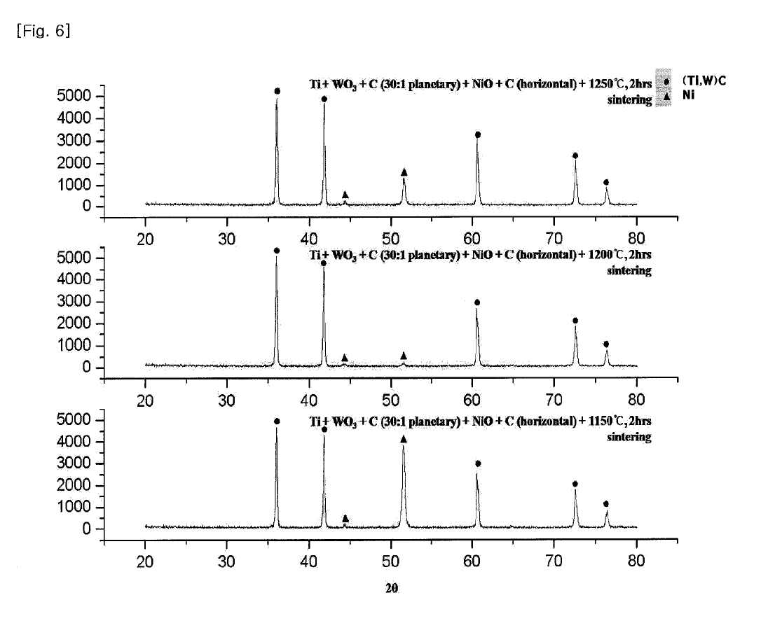

FIG. 6 illustrates the XRD results of the powders prepared by reducing and carburizing the powders of FIG. 5(b) at 1,150° C., 1,200° C. and 1,250° C. for 2 hours. As can be seen in FIG. 6, powders and sintered bodies having only solid solution phase and Ni phase were obtained at such low temperatures as 1,150° C. and 1,200° C.

Table 3 shows the carbon and oxygen analysis results of the reduced and carburized powders and mechanical properties thereof (in Table 3, pl. and hor. represent the addition of NiO during planetary milling and the addition of NiO during horizontal milling of NiO, respectively). The oxygen content of the powder prepared by adding NiO during horizontal milling followed by heat-treating at 1,150° C. was so large as to be 1.68%, whereas the oxygen content of the powders prepared by heat-treating at 1,200° C. and 1,250° C. were so reasonable as to be below 0.5%. It appeared that carbon was deficient in that the oxygen content of the powder prepared by adding NiO together with Ti, WO₃ and C during planetary milling followed by heat-treating at 1,250° C. was somewhat so large as to be 0.7%, and the measured amount of carbon was very different from the calculated amount of carbon.

TABLE 3

| | | 1150° C. | | 1200° C. | | 1250° C. | |
|---|---|---|---|---|---|---|---|
| | | pl. | hor. | pl. | hor. | pl. | hor. |
| CNO | Total | — | 9.884 | — | 9.845 | 7.405 | 9.217 |
| | carbon | | | | | | |
| | (%) | | | | | | |
| | Total | — | 1.68 | — | 0.423 | 0.723 | 0.296 |
| | oxygen | | | | | | |
| | (%) | | | | | | |
| properties | Hᵥ | — | 11.4 | — | 10.8 | — | 10.7 |
| | K_{IC} | — | 12.2 | — | 12.4 | — | 11.8 |

In addition, when NiO was added after planetary milling, K₁ of the powders prepared by reduction at 1,150° C., 1,200° C. and 1,250° C. were all about 12 MPam^{1/2}, which tells that the powders have excellent toughness.

It can be appreciated from Example 3 that the oxygen content in (Ti,W)C—Ni diminished significantly when NiO was mixed with the mixture of metal and oxides after grinding the metal and oxides. Furthermore, a solid solution powder with very small oxygen content was able to be prepared when only WO₃, carbon powder and Ti are used. A complete solid solution was also able to be prepared at low temperature such as 1,150° C. and 1,200° C.

### Example 4

In order to produce (Ti_{0.7}W_{0.3})C-20 wt % Ni cermet sintered body, Ti metal and TiO₂, WO₃ and NiO oxides were prepared according to the compositions of the cermet sintered body. Ti, TiO₂, WO₃ and carbon were first mixed and ground so as the ratio of TiO₂:Ti to be (a) 0:1, (b) 1:1, (c) 2:1 and (d) 1:0, respectively, and NiO was mixed therewith through horizontal ball milling, followed by reduction and carburization to obtain (Ti_{0.7}W_{0.3})C-20 wt % Ni powders. The reduction and carburization was carried out in a graphite vacuum furnace at 1,250° C. for 2 hours. The thus prepared (Ti_{0.7}W_{0.3})C-20 wt % Ni cermet powders were sintered in the graphite vacuum furnace at ordinary sintering temperature of 1,510° C. for 1 hour under vacuum of 10⁻² Torr. The XRD results showed that all the powders ((a)-(d)) were comprised of a complete solid solution and Ni.

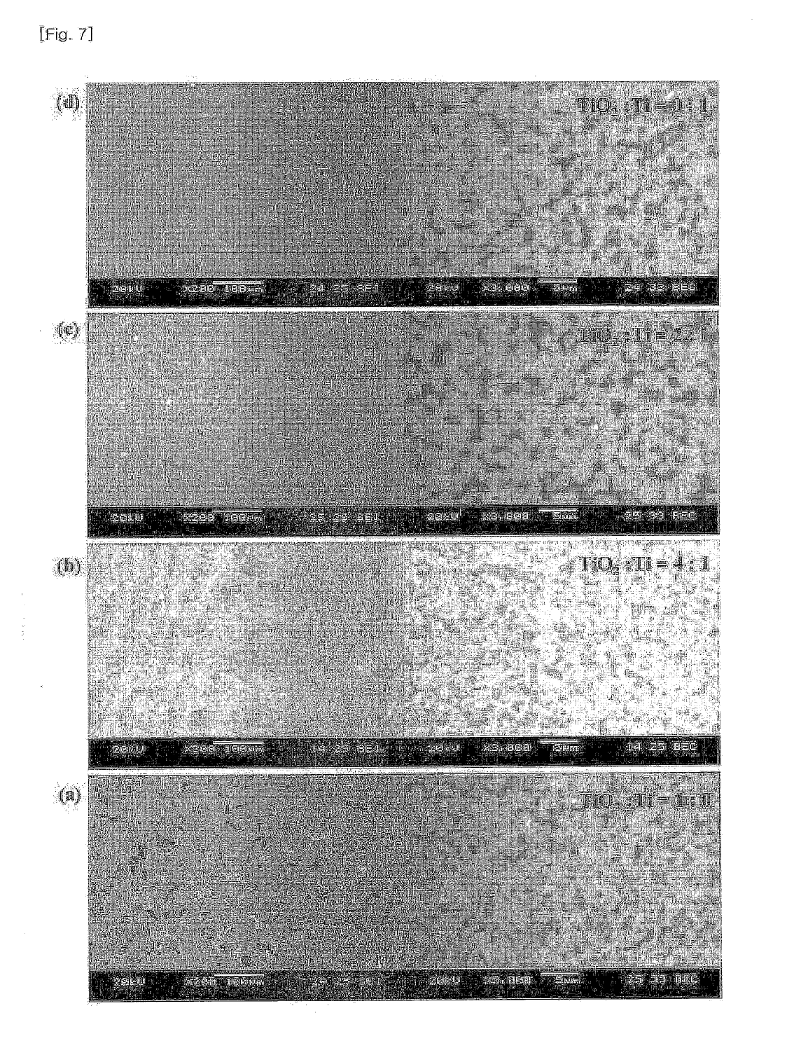

FIG. 7 shows field emission scanning electron microscopic (FESEM) images of the microstructures of the (Ti_{0.7}W_{0.3})C-20 wt % Ni cermet sintered bodies produced by reducing and carburizing the powders prepared by mixing and grinding the mixtures of Ti, TiO₂, WO₃ and C, in which the ratio of TiO₂:Ti are (a) 0:1, (b) 2:1, (c) 4:1 and (d) 1:0, respectively, according to Example 4 of the present invention.

In FIG. 7(a) of TiO₂:Ti=1:0, many pores were observed within the sintered body. It was also observed that sinterability changed depending sensitively on the reduction and carburization process conditions of the powders. However, as shown FIG. 7(b), (c) and (d) of the TiO₂:Ti ratio of 4:1, 2:1 and):1, respectively, sinterability was greatly enhanced and the reduction and carburization conditions were suitable. In addition, it is observed that the microstructures of all the sintered body contained only a single solid solution phase.

Table 4 shows mechanical properties of the cermets prepared according to one embodiment of the present invention.

TABLE 4

| | Hᵥ(Gpa) | K_{1C}(MPam^{1/2}) |
|---|---|---|
| TiO₂:Ti = 0:1 | 12.1 | 11.3 |
| TiO₂:Ti = 2:1 | 10.6 | 15.1 |
| TiO₂:Ti = 4:1 | 11.7 | 11.3 |
| TiO₂:Ti = 1:0 | — | — |

As can be seen in Table 4, although the cermets prepared from the mixtures of Ti metal and TiO₂, WO₃ oxides, had simple compositions, their toughness was as high as up to 11 MPam^{1/2} to 15 MPam^{1/2}. However, the cermets prepared from the oxide mixtures of TiO₂, WO₃, NiO, etc. could not have constant mechanical properties and microstructures at the above-mentioned conditions.

Therefore, in contrast to the conventional technology, improved powders which have small oxygen content and high sinterability can be prepared at low reduction temperature when (Ti_{0.7}W_{0.3})C-20 wt % Ni cermet powders are prepared by mixing and grinding Ti with TiO₂.

### Example 5

In order to prepare three types of solid solutions, (Ti₁₋ₓWₓ)(CN) (x=0.0.7, 0.12, 0.30), Ti metal and anatase TiO₂ and WO₃ were mixed together and ground followed by reducing and carbonitriding the mixture. The mixture ratio of TiO₂ and Ti was determined to be 4:1 and WO₃ and carbon powder were mixed with TiO₂ and Ti, and the mixture was ground in planetary mill at 250 rpm for 20 hours in a dry state followed by reduction and carburization. The reduction and carburization was carried out in a graphite vacuum furnace at 1,300° C. for 2 hours.

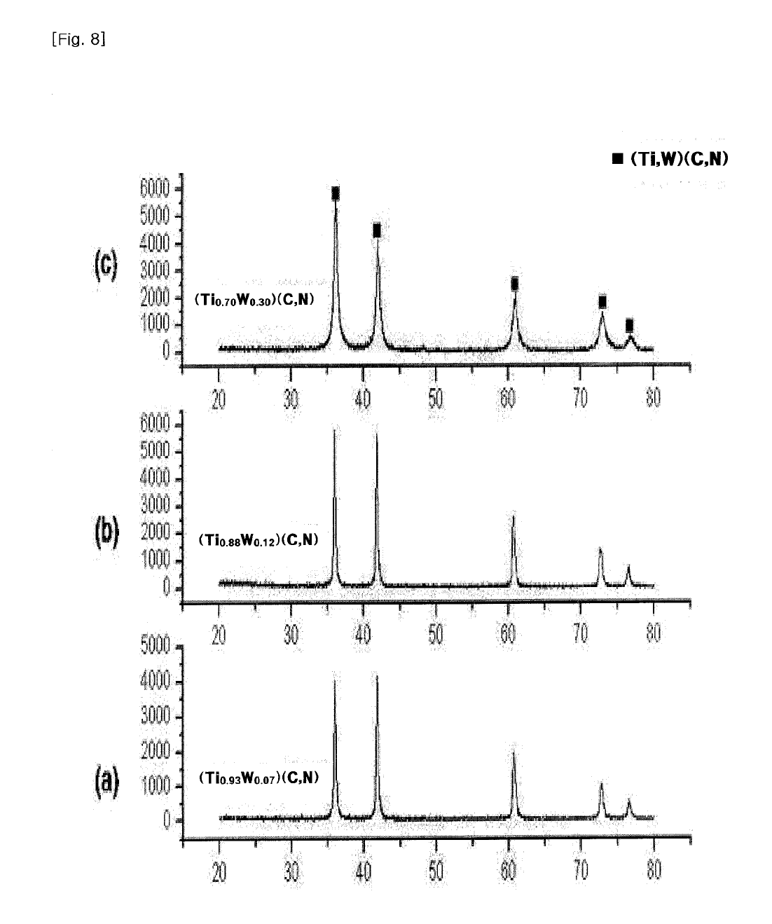

FIG. 8 illustrates the XRD results of the powders prepared by reducing and carbonitriding the milled powders. It is observed that solid solution carbonitrides with crystallites of 30 nm to 80 nm were formed in all compositions of (a) (Ti_{0.7}W_{0.3})(CN), (b) (Ti_{0.88}W_{0.12})(CN) and (c) (Ti_{0.93}W_{0.07})(CN).

Table 5 shows the results of the total carbon, oxygen, nitrogen and free carbon contents of the reduced and carburized powders. As solid-solubilized W increased, the free carbon and nitrogen contents decreased. The powders heat-treated at 1,300° C. showed, in all the compositions, favorable oxygen contents of below 1 wt %. Carbon/nitrogen ratio of the nitrided powders was about 0.75/0.25, which showed that nitriding were carried out successfully. When (Ti_{0.70}W_{0.30})(C,N) was prepared at the mixture ratio of TiO₂ and Ti of 4:1, more nitrogen was contained in the solid solution powder, compared with the powders prepared by using only TiO₂.

TABLE 5

| | solid solution | | | |
|---|---|---|---|---|
| | composition | | | |
| | mixture ratio | | | |
| | (carbonitriding temp. and time) | | | |
| | (Ti_{0.93}W_{0.07})(C,N) | (Ti_{0.83}W_{0.12})(C,N) | (Ti_{0.70}W_{0.30})(C,N) | (Ti_{0.70}W_{0.30})(C,N) |
| | TiO₂:Ti = 4:1 | TiO₂:Ti = 4:1 | TiO₂:Ti = 4:1 | TiO₂:Ti = 1:0 |
| | (1300° C., 2 hr) | (1300° C., 2 hr) | (1300° C., 2 hr) | (1300° C., 1 hr) |
| Total Carbon | 14.70 | 13.65 | 10.05 | 10.39 |
| Free Carbon | 3.06 | 2.02 | 1.54 | 0.49 |
| Nitrogen | 4.68 | 3.68 | 2.68 | 1.61 |
| Oxygen | 0.69 | 0.39 | 0.74 | 0.26 |
| C/N ratio | 0.74/0.26 | 0.76/0.24 | 0.76/0.24 | 0.88/0.12 |

It can be understood from Example 5 that (Ti,W)(CN) solid solution carbonitride powders of which residual oxygen content was reasonable (<0.8 wt %) were able to be prepared by mixing and grinding Ti, TiO₂ and WO3 followed by reducing and carbonitriding at 1,300° C. and for 2 hours.

### Example 6

In order to prepare solid solution carbonitride cermets, Ti metal, and anatase TiO₂ and WO₃ oxides were mixed and ground, and then reduced and carbonitrided to synthesize (Ti,W)(CN)—Ni solid solution carbonitride cermet powders. Sintered bodies were prepared by using the cermet powders and the mechanical properties thereof were investigated. Three cermet compositions of (Ti₁₋ₓWₓ)(CN)-20 wt % Ni (x=0.0.7, 0.12, 0.30) were selected. Ni metal powders were mixed with the solid solution powders prepared in Example 5 through horizontal ball milling for 24 hours, and using the thus prepared (Ti_{0.7}W_{0.3})(CN)—Ni cermet powders, sintering was performed in a graphite vacuum furnace at ordinary sintering temperature of 1,510° C. for 1 hour under vacuum of 10⁻² torr. The XRD results show that all the sintered bodies were comprised of a complete solid solution and Ni.

FIG. 9 illustrates the FESEM images of the microstructures of the sintered bodies of the (Ti₁₋ₓWₓ)(CN)—20 wt % Ni (x=0.07, 0.12, 0.30) cermet powders which were produced by reducing and carburizing the powders prepared by mixing the starting materials so as to be the TiO₂:Ti ratio of 4:1 and grinding thereof, according to Example 6 of the present invention.

The (Ti_{0.93}W_{0.07})(C_{0.74}N_{0.26})-20 Ni sintered body of FIG. 9(a) and the (Ti_{0.88}W_{0.12})(C_{0.76}N_{0.24})-20Ni sintered body of FIG. 9(b) had more or less many pores, which was due to large amount of free carbon as shown in Table 5. Only complete solid solution grains are shown in the microstructures.

The (Ti_{0.7}W_{0.3})(C_{0.76}W_{0.24})-20Ni sintered body of FIG. 9(c) showed excellent sintering result and fine complete solid solution phase microstructure with size of below 1 μm.

Table 6 shows the mechanical properties of the (Ti_{0.7}W_{0.3})(C_{0.76}N_{0.24})-xNi sintered bodies, which were measured by changing the amount of a binder phase (x=15, 18, 20 wt %) in the (Ti_{0.7}W_{0.3})(C_{0.76}W_{0.24}) solid solution carbonitride of FIG. 9(c).

TABLE 6

| | (Ti_{0.7}W_{0.3})(C_{0.76}N_{0.24})—20Ni | (Ti_{0.7}W_{0.3})(C_{0.76}N_{0.24})—18Ni | (Ti_{0.7}W_{0.3})(C_{0.76}N_{0.24})—15Ni |
|---|---|---|---|
| Hᵥ(Gpa) | 12.7 | 13.1 | 14.2 |
| K_{1C}(MPam^{1/2}) | 13.7 | 12.5 | 10.8 |

As shown in Table 6, as the amount of Ni binder phase decreased, hardness (Hᵥ) increased from 12.7 GPa to 14.2 GPa and toughness decreased from 13.7 MPam^{1/2} to 10.8 MPam^{1/2}. Especially, (Ti_{0.7}W_{0.3})(C_{0.76}N_{0.24})-15Ni has a similar amount of a binder phase, compared with WC-7Co (14.7 GPa, 10.3 MPam^{1/2}) and comparable mechanical properties, and therefore shows the possibility of substituting for hardmetals.

It can be known from Example 6 that (Ti,W)(CN)—Ni with excellent mechanical properties was able to be prepared by mixing Ni powders with (Ti,W)(CN) solid solution powders produced by mixing and grinding the mixture of Ti, anatase TiO₂ and WO₃ followed by reducing and carbonitriding the mixture. In addition, the mechanical properties could be controlled by adjusting the amount of the binder phase.

As described above, the solid solution powder, method for preparing thereof, and cermet prepared from cermet powder containing the solid solution powder, according to the present invention, can improve low toughness of TiC or TiCN cermets and, therefore, are applicable to materials for cutting tools, die, etc.

### Example 7

### Surface Modification

### Hardened Layer Formation

In order to prepare (Ti,W)C-20 wt % Ni cermet sintered body, mixture of TiO₂, WO₃, NiO and carbon powder was ground, using WC—Co balls, in a planetary mill at 250 rpm with BPR of 20:1 for 20 hours in a dry state, then cermet powders were prepared by reducing and carburizing the ground powders in a vacuum furnace at 1,300° C. for 2 hours, and finally formation of solid solution carbides were confirmed by XRD. The thus prepared cermet powders were sintered at 1,510° C. for 1 hour to obtain (i) (Ti_{0.93}W_{0.07})C-20 wt % Ni and (ii) (Ti_{0.84}W_{0.16})C-20 wt % Ni. During sintering, nitrogen at 1 torr to 100 torr was injected into the graphite vacuum furnace at 1,510° C. and the pressure maintained until cooling procedure completed.

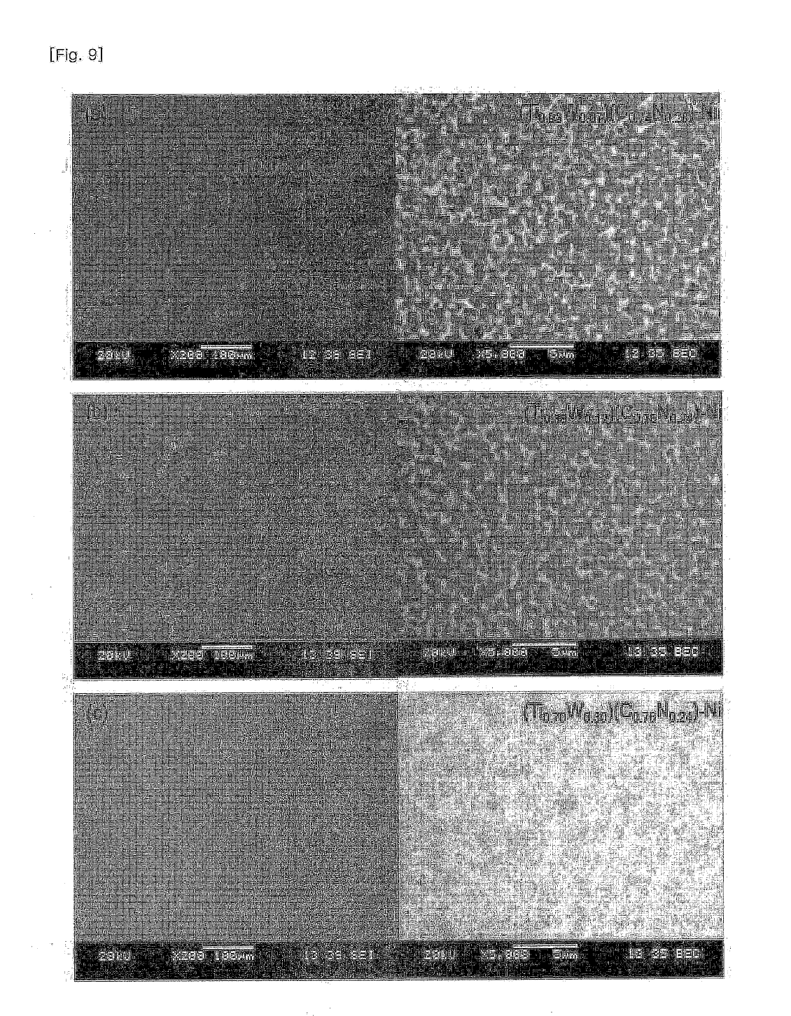

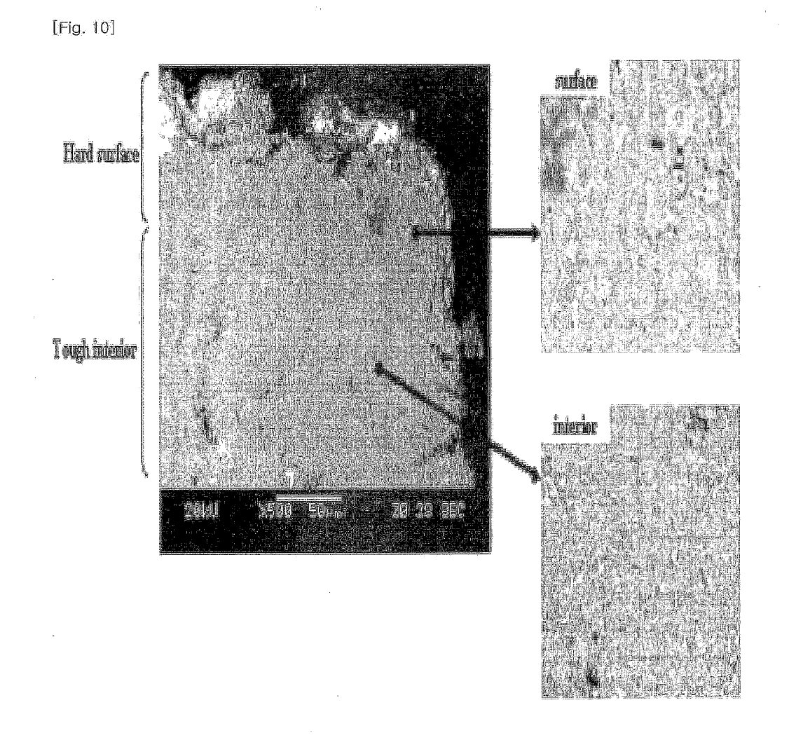

FIG. 10 illustrates the FESEM images of the sintered body which was prepared by sintering the (Ti_{0.93}W_{0.07})C-20 wt % Ni cermet powders at 1,510° C. for 1 hour under nitrogen atmosphere (at about 100 torr).

As can be seen in FIG. 10, two types of different (Ti,W)C—Ni complete solid solution were formed at the surface of and within the sintered body. The (Ti_{0.93}W_{0.07})C-20 wt % Ni sintered body was prepared through the sintering process (at 1,510° C. for 1 hour) and cooling process under nitrogen atmosphere (about 100 torr).

Element analysis results of the surface and internal solid solution phase of the cermet sintered under nitrogen atmosphere through SEM/EDS are shown Table 7.

TABLE 7

| | internal (%) | surface (%) |
|---|---|---|
| Ti | 89.49 | 92.44 |
| W | 10.51 | 7.56 |
| total | 100 | 100 |

As shown in Table 7, the compositions of the solid solution phases formed are different from each other. The solid solution phase near the surface has larger amount of Ti than the internal. Hardness of the TiC/Ti(CN)-based solid solution increases with Ti amount in the solid solution phase. In addition, FIG. 10 shows the grain growth of the solid solution phase along with an increase of the metal binder phase near the surface. In contrast, FIG. 11 illustrates the FESEM image of the surface of the sintered body which was prepared by sintering the (Ti_{0.84}W_{0.16})C-20 wt % Ni cermet powders at 1,510° C. for 1 hour under nitrogen atmosphere (at about 100 torr).

As shown in FIG. 11, a very hard phase of Ti with black color is observed in the microstructure of the surface of the sintered body.

### Example 8

### Application of Coating

In order to prepare (Ti,W)C-20 wt % Ni cermet sintered body, mixture of TiO₂, WO₃, NiO and carbon powder was ground, using WC—Co balls, in a planetary mill at 250 rpm with BPR of 20:1 for 20 hours in a dry state, then cermet powders were prepared by reducing and carburizing the ground powders in a vacuum furnace at 1,300° C. for 2 hours. The thus prepared cermet powders were sintered at 1,510° C. for 1 hour to obtain (i) (Ti_{0.93}W_{0.07})C-20 wt % Ni, (ii) (Ti_{0.84}W_{0.16})C-20 wt % Ni, (iii) (Ti_{0.93}W_{0.07})(CN)-20 wt % Ni and (iv) (Ti_{0.84}W_{0.16})(CN)-20 wt % Ni, and formation of complete solid solution carbides/carbonitrides were confirmed by XRD. TiN coating layer was formed on the surface of the cermet sintered according to PVD method.

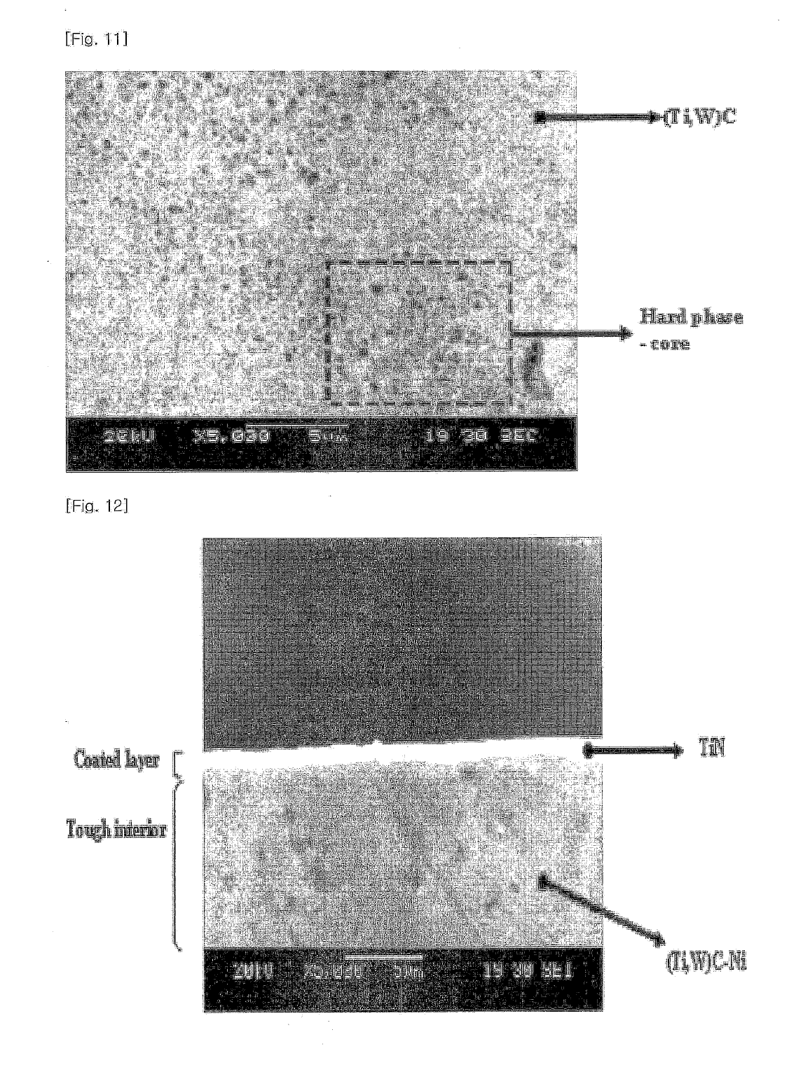

FIG. 12 the FESEM image of the surface of the TiN coating layer coated by PVD after sintering the (Ti,W)C—Ni cermet powders (containing 15 wt % of WC) at 1,510° C. for 1 hour.

Mechanical properties of the cermets of the present invention are shown in Table 8.

TABLE 8

| | | | internal | | TiN coating layer | |
|---|---|---|---|---|---|---|
| | | | hardness | toughness | hardness | toughness |
| condition | composition | | (GPa) | (MPa m^{1/2}) | (GPa) | (MPa m^{1/2}) |
| 1,510° C., | (Ti,W)C—Ni | 15WC | 12.3 | 13.2 | 14.3 | 8.8 |
| 1 h | | 30WC | 11.1 | 13.8 | 14.1 | 8.8 |
| | (Ti,W)(CN)—Ni | 15WC | 12.2 | 12.0 | 15.3 | 10.2 |
| | | 30WC | 11.2 | 12.6 | 14.8 | 9.3 |

Table 8 shows that although the coating layer has lower toughness than that of interanal phase and, however, the coating layer shows higher hardness than that of internal phase. Therefore, the coating on a cermet having high toughness results in realizing various properties of cutting tools. The surface of a cermet is often coated with TiN in order to improve hardness and toughness.

### Example 9

### Compositions and Ceramics

In order to prepare (Ti,W)C cermet sintered body, mixture of TiO₂, WO₃, NiO and carbon powder was ground, using WC—Co balls, in a planetary mill at 250 rpm with BPR of 20:1 for 20 hours in a dry state, then cermet powders were prepared by reducing and carburizing the ground powders in a vacuum furnace at 1,300° C. for 2 hours, and finally formation of solid solution carbides were confirmed by XRD. The thus prepared cermet powders were sintered at 1,510° C. for 1 hour to obtain four compositions of (Ti,W)C, namely, (Ti_{0.8}W_{0.2})C, (Ti_{0.7}W_{0.3})C, (Ti_{0.6}W_{0.4})C and (Ti_{0.5}W_{0.5})C.

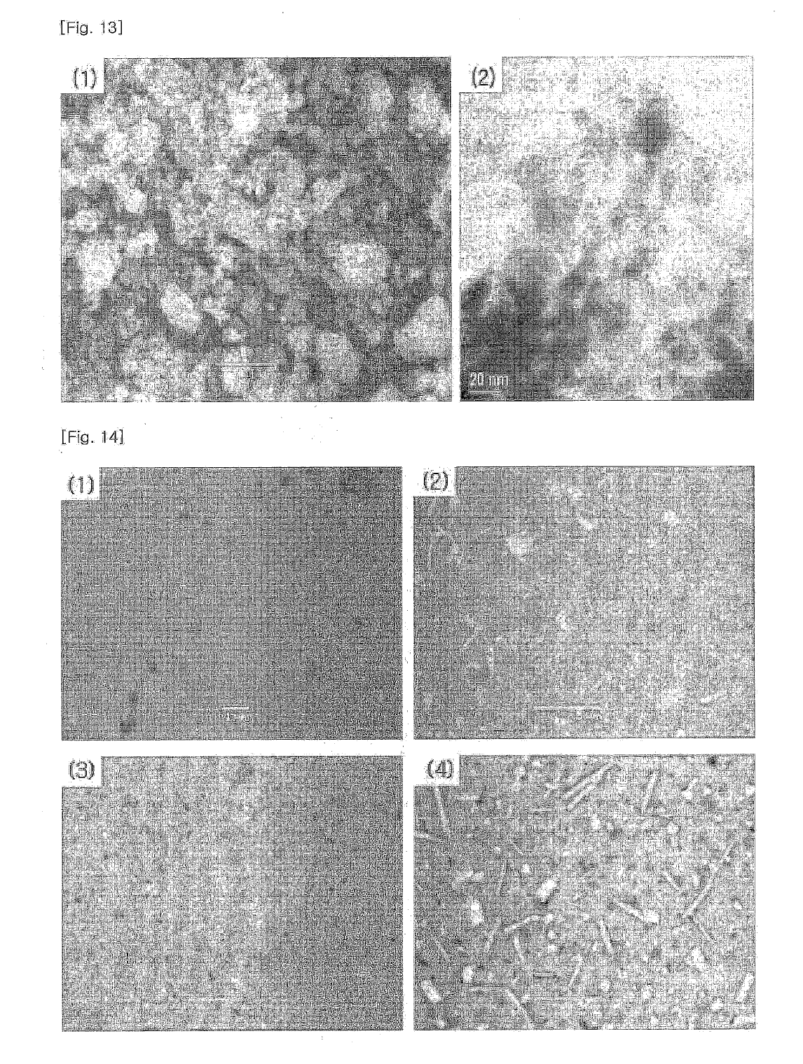

FIG. 13 illustrates the SEM (scanning electron microscopy) and TEM (transmission electron microscopy) images of the (Ti_{0.8}W_{0.2})C powders prepared by the one embodiment of the present invention. It can be confirmed from the SEM image of FIG. 13 that powders were formed into homogeneous agglomerates of about 100 nm to 1 μm in a given scale. It can be also confirmed from the TEM image of FIG. 13 that powders were formed into small carbide agglomerates of about 20 nm to 50 nm in a given scale.

Table 9 shows the CNO element analysis results of the powders prepared through the above procedures on the basis of the above compositions.

TABLE 9

| composition | C | N | O |
|---|---|---|---|
| (Ti_{0.8}W_{0.2})C | 11.566 | 0.258 | 0.058 |
| (Ti_{0.7}W_{0.3})C | 10.658 | 0.222 | 0.086 |
| (Ti_{0.6}W_{0.4})C | 9.003 | 0.072 | 0.02 |
| (Ti_{0.5}W_{0.5})C | 8.508 | 0.033 | 0.022 |

As shown in Table 9, the oxygen contents of the (Ti,W)C solid solution powders prepared are smaller that those of the commercial powders, and becomes to be much smaller with increase of WC.

Table 10 lists various solid solution powders prepared by the above procedures on the basis of the above compositions.

TABLE 10

| compositions of 2 | | |
|---|---|---|
| phase solid solution | compositions of 23 phase | compositions of 24 phase solid |
| (wt %) | solid solution (wt %) | solution (wt %) |
| (Ti,5Nb)C—20Ni | (Ti,15W,5Mo)(CN)—20Ni | (Ti,15W,3Mo,1Nb)(CN)—20Ni |
| (Ti,10Mo)C—20Ni | (Ti,15W,10Mo)(CN)—20Ni | (Ti,15W,5Mo,3Nb)(CN)—15Co |
| (Ti,20Mo)C—20Ni | (Ti,5W,30Mo)(CN)—20Ni | (Ti,15W,10Mo,5Nb)(CN)—20Ni |
| (Ti,30Mo)C—20Ni | (Ti,10W,20Mo)(CN)—20Ni | (Ti,15W,10Mo,5Nb)(CN)—7.5Co—7.5Ni |
| (Ti,40Mo)C—20Ni | (Ti,10Mo,5Nb)(CN)—20Ni | (Ti,15W,3Mo,1Ta)(CN)—20Ni |
| (Ti,15Mo)(CN)—20Ni | (Ti,10Mo,5Nb)(CN)—15Co | (Ti,15W,5Mo,3Ta)(CN)—20Ni |
| (Ti,15W)C—20Ni | (Ti,10Mo,5Nb)(CN)—7.5Co—7.5Ni | (Ti,15W,5Mo,3Ta)(CN)—15Co |
| (Ti,15W)(CN)—20Ni | (Ti,10Mo,10Nb)(CN)—20Ni | |
| (Ti,30W)C—20Ni | (Ti,15Mo,5Nb)(CN)—20Ni | |
| (Ti,30W)(CN)—20Ni | (Ti,20Mo,5Nb)(CN)—20Ni | |
| | (Ti,20Mo,10Nb)(CN)—20Ni | |
| | (Ti,30Mo,5Nb)(CN)—20Ni | |

The various complete solid solution powders listed in Table 10 are the exemplary powder compositions which can be used for the same purposes as those in Examples of the present invention.

The powders of four compositions in Table 9, prepared by the above-mentioned methods were sintered without a binder phase such as Ni at ordinary sintering temperature of 1,510° C. for 1 hour under vacuum of about 10 torr.

FIG. 14 illustrates the photographs of the microstructures of the samples of (1) the (Ti_{0.8}W_{0.2})C sintered body fabricated at 1,120° C., (2) the (Ti_{0.7}W_{0.3})C sintered body fabricated at 1,120° C., (3) the (Ti_{0.6}W_{0.4})C sintered body fabricated at 1,200° C. and (4) the (Ti_{0.5}W_{0.5})C sintered body fabricated at 1,200° C., respectively.

As can be seen in FIG. 14, dense sintered bodies were obtained even in the case of sintering only (Ti,W)C solid solution powders without a binder such as Ni.

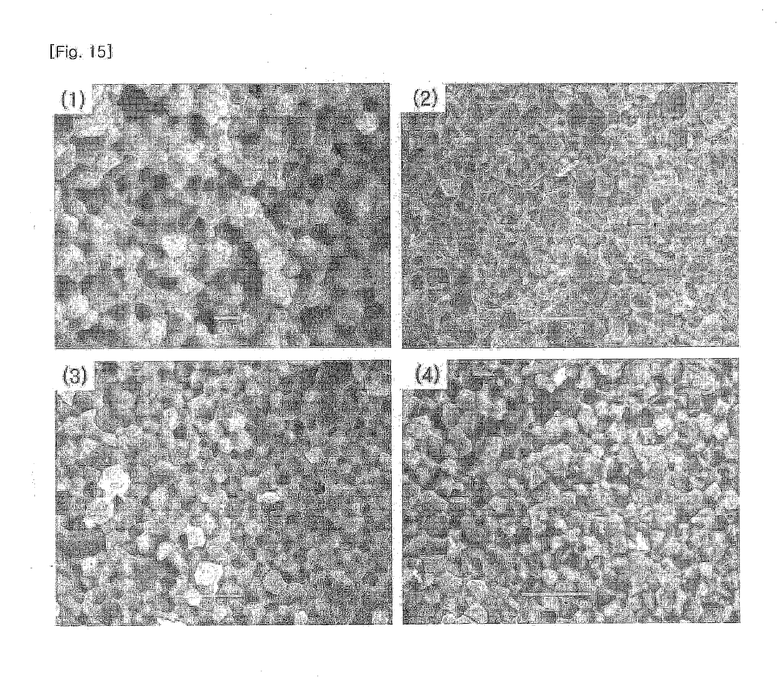

FIG. 15 illustrates the SEM images which show the sectional images of the sintered bodies having crystallite sizes of about 1 μm.

Table 11 shows mechanical properties of the ceramics prepared according to one embodiments of the present invention. As can be seen in Table 11, although solid solution ceramics formed, such as (Ti,W)C and (Ti,W,Nb)C, had simple compositions, they showed high sintered densities and low porosities. Moreover, Hᵥ values of the solid solution ceramics of the present invention showed high hardness of up to 6 MPam^{1/2} to 8 MPam^{1/2}, compared with those of the conventional cermets, and also showed stable toughness values. In addition, these mechanical properties showed higher hardness and toughness than the conventional ceramics, and therefore possibility to be used for high speed cutting tool material.

TABLE 11

| TiC—58WC | | TiC—69WC | | TiC—77WC | | TiC—66WC—2NbC | | TiC—64WC—2NbC—2MoC | |
|---|---|---|---|---|---|---|---|---|---|
| Hardness | Toughness | Hardness | Toughness | Hardness | Toughness | Hardness | Toughness | Hardness | Toughness |

| | | | | | | | | | | |
|---|---|---|---|---|---|---|---|---|---|---|
| A | 19.4 | 7.4 | 19.6 | 7.4 | 18 | 7.9 | 18.6 | 7.4 | 19.1 | 7.7 |
| B | 19 | 6.6 | 17.8 | 6.5 | 18 | 7 | 18 | 7.4 | 18.7 | 7.4 |
| C | 17.4 | 7.9 | 18.6 | 8 | — | — | 19.8 | 7.6 | 19.9 | 6.8 |

(wt % WC; Unit of hardness: GPa; Unit of toughness: MPam^{1/2})

1. A complete solid solution powder of carbide or carbonitride of at least two metals, including Ti, selected from the group consisting of Ti, Zr, Hf, V, Nb, Ta, Cr, Mo and W, wherein starting materials for the preparation of said complete solid solution powder comprise said at least two metals, an oxide thereof and a carbon powder.

2. A sintered body of a complete solid solution powder of carbide or carbonitride of at least two metals, including Ti, selected from the group consisting of Ti, Zr, Hf, V, Nb, Ta, Cr, Mo and W, wherein starting materials for the preparation of said complete solid solution powder comprise said at least two metals, an oxide thereof and a carbon powder.

3. A cermet powder of carbide or carbonitride of at least two metals, including Ti, selected from the group consisting of Ti, Zr, Hf, V, Nb, Ta, Cr, Mo and W, wherein starting materials for the preparation of said powder are a complete solid solution powder comprising said at least two metals, oxides of said at least two metals, and carbon powder; and an aggregate comprising at least one metal selected from the group consisting of nickel, iron and cobalt.

4. A cermet prepared by sintering a cermet powder of carbide or carbonitride of at least two metals, including Ti, selected from the group consisting of Ti, Zr, Hf, V, Nb, Ta, Cr, Mo and W, wherein starting materials for the preparation of said powder are a complete solid solution powder comprising said at least two metals, oxides of said at least two metals, and carbon powder; and an aggregate comprising at least one metal selected from the group consisting of nickel, iron and cobalt.

5. A method for preparing a complete solid solution powder, comprising:
i) step 1 of mixing, or mixing and grinding at least two metals, including Ti, selected from the group consisting of Ti, Zr, Hf, V, Nb, Ta, Cr, Mo and W, oxides of said at least two metals, and carbon powder; and
ii) step 2 of reducing and carburizing, or reducing, carburizing and nitriding said mixed, or mixed and ground powder.

6. The method of claim 5, wherein said powder is reduced and carburized at 1,100° C. to 1,400° C. for less than 3 hours under vacuum or hydrogen atmosphere to produce a complete solid solution carbide, or said powder is reduced, carburized and nitrided at 1,100° C. to 1,400° C. for less than 3 hours under nitrogen atmosphere to produce a complete solid solution carbonitride, at the step 2.

7. A method for preparing a sintered body, comprising:
i) step 1 of mixing, or mixing and grinding at least two metals, including Ti, selected from the group consisting of Ti, Zr, Hf, V, Nb, Ta, Cr, Mo and W, oxides of said at least two metals, and carbon powder;
ii) step 2 of reducing and carburizing, or reducing, carburizing and nitriding said mixed, or mixed and ground powder; and
iii) step 3 of compacting and sintering said complete solid solution powder obtained at the step 2.

8. The method of claim 7, wherein said powder is reduced and carburized at 1,100° C. to 1,400° C. for less than 3 hours under vacuum or hydrogen atmosphere to produce a complete solid solution carbide, or said powder is reduced, carburized and nitrided at 1,100° C. to 1,400° C. for less than 3 hours under nitrogen atmosphere to produce a complete solid solution carbonitride, at the step 2.

9. The method of claim 7, wherein said complete solid solution powder is sintered at 1,250° C. to 1,600° C. for 0.1 to 3 hours under vacuum or nitrogen atmosphere at the step 3.

10. A method for preparing a cermet powder, comprising:
i) step 1-2 of mixing, or mixing and grinding at least one oxide selected from the group consisting of nickel, cobalt and iron, at least two metals, including Ti, selected from the group consisting of Ti, Zr, Hf, V, Nb, Ta, Cr, Mo and W, oxides of said at least two metals, and carbon powder; and
ii) step 2-2 of reducing and carburizing, or reducing, carburizing and nitriding said mixed, or mixed and ground powder.

11. The method of claim 10, wherein said powder is reduced and carburized at 1,100° C. to 1,400° C. for less than 3 hours under vacuum or hydrogen atmosphere to produce a complete solid solution carbide, or said powder is reduced, carburized and nitrided at 1,100° C. to 1,400° C. for less than 3 hours under nitrogen atmosphere to produce a complete solid solution carbonitride, at the step 2-2.

12. A method for preparing a cermet, comprising:
i) step 1-2 of mixing, or mixing and grinding an oxide of at least one selected from the group consisting of nickel, cobalt and iron, at least two metals, including Ti, selected from the group consisting of Ti, Zr, Hf, V, Nb, Ta, Cr, Mo and W, oxides of said at least two metals, and carbon powder;
ii) step 2-2 of reducing and carburizing, or reducing, carburizing and nitriding said mixed, or mixed and ground powder; and
iii) step 2-3 of compacting and sintering said cermet powder obtained at the step 2-2.

13. The method of claim 12, wherein said powder is reduced and carburized at 1,100° C. to 1,400° C. for less than 3 hours under vacuum or hydrogen atmosphere to produce a complete solid solution carbide, or said powder is reduced, carburized and nitrided at 1,100° C. to 1,400° C. for less than 3 hours under nitrogen atmosphere to produce a complete solid solution carbonitride, at the step 2-2.

14. The method of claim 12, wherein said cermet powder is sintered at 1,250° C. to 1,600° C. for 0.1 to 3 hours under vacuum or nitrogen atmosphere at the step 2-3.

15. A method for preparing a cermet powder, comprising:
i) mixing, or mixing and grinding at least two metals, including Ti, selected from the group consisting of Ti, Zr, Hf, V, Nb, Ta, Cr, Mo and W, oxides of said at least two metals, and carbon powder;
ii) reducing and carburizing, or reducing, carburizing and nitriding said mixed, or mixed and ground powder to prepare a complete solid solution powder; and
iii) adding at least one metal selected from the group consisting of nickel, cobalt and iron to said complete solid solution powder.
